(19) United States
(12) Patent Application Publication
(10) Pub. No.: US 2008/0144213 A1
(43) Pub. Date: Jun. 19, 2008

(54) PERPENDICULAR MAGNETIC RECORDING MEDIUM WITH LAMINATED MAGNETIC LAYERS SEPARATED BY A FERROMAGNETIC INTERLAYER FOR INTERGRANULAR EXCHANGE-COUPLING ENHANCEMENT

(75) Inventors: Andreas Klaus Berger, San Jose, CA (US); David Thomas Margulies, Salinas, CA (US); Natacha F. Supper, Campbell, CA (US)

Correspondence Address: THOMAS R. BERTHOLD, 18938 CONGRESS JUNCTION COURT, SARATOGA, CA, 95070, US

(73) Assignee: HITACHI GLOBAL STORAGE TECHNOLOGIES NETHERLANDS B.V., San Jose, CA (US)

(21) Appl. No.: 11/611,766

(22) Filed: Dec. 15, 2006

(51) Int. Cl. G11B 5/127; G11B 5/66

(52) U.S. Cl. 360/110; 428/827

(57) ABSTRACT

A perpendicular magnetic recording layer (RL) structure has multiple granular ferromagnetic layers (MAGs) that are separated by ferromagnetic exchange-coupling layers (ECLs) as interlayers between the MAGS. The ECLs provide effective intergranular exchange-coupling in the MAGs. Each MAG is sufficiently thick to support independent recording states that are thermally stable, and does not rely on the overall RL thickness for thermal stability. Each ECL has significant intralayer coupling of its grains. The material of the ECL may be a CoCr alloy, such as a CoCrPtB alloy. The Cr and B in the ECL create sam11 segregation regions or sub-grains in the ECL that are exchange-coupled on a length-scale smaller than the grain size. For each MAG grain, there exist a multitude of magnetic states corresponding to different transition positions in the ECL. These magnetic states are metastable and can be produced by a recording process, which in turn allows the RL structure to support a stable magnetization pattern with different magnetization states in adjacent MAGs. Thus, the magnetization states of the various MAGs may be fully correlated, but need not be fully correlated.

### BACKGROUND OF THE INVENTION

1. Field of the Invention

This invention relates generally to perpendicular magnetic recording media, such as perpendicular magnetic recording disks for use in magnetic recording hard disk drives, and more particularly to a perpendicular magnetic recording medium with laminated magnetic layers.

2. Description of the Related Art

Horizontal or longitudinal magnetic recording media, wherein the written or recorded bits are oriented generally parallel to the surfaces of the disk substrate and the planar recording layer, have been the conventional media used in magnetic recording hard disk drives. Perpendicular magnetic recording media, wherein the recorded bits are stored in the recording layer in a generally perpendicular or out-of-plane orientation (i.e., other than parallel to the surfaces of the disk substrate and the recording layer), provides a promising path toward ultra-high recording densities in magnetic recording hard disk drives. A common type of perpendicular magnetic recording system is one that uses a “dual-layer” medium. This type of system is shown in FIG. 1 with a single write pole type of recording head. The dual-layer medium includes a perpendicular magnetic data recording layer (RL) on a “soft” or relatively low-coercivity magnetically permeable underlayer (SUL) formed on the substrate.

The SUL serves as a flux return path for the field from the write pole to the return pole of the recording head. In FIG. 1, the RL is illustrated with perpendicularly recorded or magnetized regions, with adjacent regions having opposite magnetization directions, as represented by the arrows. The magnetic transitions between adjacent oppositely-directed magnetized regions are detectable by the read element or head as the recorded bits. The read head is typically located between shields of magnetically permeable material to ensure that recorded bits other than the bit being read do not affect the read head.

FIG. 2 is a schematic of a cross-section of a prior art perpendicular magnetic recording disk. The disk also includes the hard disk substrate that provides a generally planar surface for the subsequently deposited layers. The generally planar layers formed on the surface of the substrate also include a seed or onset layer (OL) for growth of the SUL, an exchange break layer (EBL) to break the magnetic exchange-coupling between the magnetically permeable films of the SUL and the RL and to facilitate epitaxial growth of the RL, and a protective overcoat (OC).

One type of conventional material for the RL is a granular polycrystalline ferromagnetic cobalt (Co) alloy, such as a CoPtCr alloy. The ferromagnetic grains of this material have a hexagonal-close-packed (hcp) crystalline structure and out-of-plane or perpendicular magnetic anisotropy as a result of the c-axis of the hcp crystalline structure being induced to grow generally perpendicular to the plane of the layer during deposition. To induce this epitaxial growth of the hcp RL, the EBL onto which the RL is formed is also typically an hcp material.

Both horizontal and perpendicular magnetic recording media that use recording layers of granular polycrystalline ferromagnetic Co alloys exhibit increasing intrinsic media noise with increasing linear recording density. Media noise arises from irregularities in the recorded magnetic transitions and results in random shifts of the readback signal peaks. High media noise leads to a high bit error rate (BER). Thus to obtain higher areal recording densities it is necessary to decrease the intrinsic media noise, i.e., increase the signal-to-noise ratio (SNR), of the recording media. The media SNR is to first order proportional to N^{1/2}, where N is the number of magnetic grains per unit area in the media. Accordingly, increases in SNR can be accomplished by increasing N. The granular cobalt alloys in the RL structure should thus have a well-isolated fine-grain structure to reduce intergranular exchange-coupling, which is responsible for high intrinsic media noise. Enhancement of grain segregation in the cobalt alloy RL can be achieved by the addition of segregants, such as oxides of Si, Ta, Ti, Nb, Cr, V, and B. These segregants tend to precipitate to the grain boundaries, and together with the elements of the cobalt alloy, form nonmagnetic intergranular material. The addition of SiO₂ to a CoPtCr granular alloy by sputter deposition from a CoPtCr—SiO₂ composite target is described by H. Uwazumi, et al., “CoPtCr—SiO₂ Granular Media for High-Density Perpendicular Recording”, IEEE Transactions on Magnetics, Vol. 39, No. 4, July 2003, pp. 1914-1918. The addition of Ta₂O₅ to a CoPt granular alloy is described by T. Chiba et al., “Structure and magnetic properties of Co—Pt—Ta₂O₅ film for perpendicular magnetic recording media”, Journal of Magnetism and Magnetic Materials, Vol. 287, February 2005, pp. 167-171.

Perpendicular magnetic recording media with RLs containing oxides or other segregants for improved SNR are subject to thermal decay. As the magnetic grains become smaller to achieve ultrahigh recording density they become more susceptible to magnetic decay, i.e., magnetized regions spontaneously lose their magnetization, resulting in loss of data. This is attributed to thermal activation of small magnetic grains (the superparamagnetic effect). The thermal stability of a magnetic grain is to a large extent determined by KᵤV, where Kᵤ is the magnetic anisotropy constant of the magnetic recording layer and V is the volume of the magnetic grain. Thus a RL with a high Kᵤ is important for thermal stability, although the Kᵤ can not be so high as to prevent writing on the RL.

In horizontal recording media, the complete absence of intergranular exchange-coupling provides the best SNR. However, in perpendicular recording media the best SNR is achieved at some intermediate level of intergranular exchange-coupling in the RL. Also, intergranular exchange-coupling improves the thermal stability of the magnetization states in the media grains. Thus in perpendicular recording media, some level of intergranular exchange-coupling is advantageous. One approach for increasing the intergranular exchange-coupling is by adding a continuous ferromagnetic exchange-coupling layer (ECL), also called a “capping” layer, on top of the underlying oxide-containing granular Co alloy magnetic layer (MAG) to provide effective intergranular exchange-coupling among the segregated grains of the MAG. The ECL is typically a CoCr—, CoPtCr—, or CoPtCrB-based ferromagnetic alloy with no oxides or other segregants, while the MAG layer is a Co—, CoPt—, or CoPtCr-based alloy with an oxide or other segregants. This type of structure is described by Choe et al., “Perpendicular Recording CoPtCrO Composite Media With Performance Enhancement Capping Layer”, IEEE TRANSACTIONS ON MAGNETICS, VOL. 41, NO. 10, OCTOBER 2005, pp. 3172-3174.

While an RL formed of a MAG with an ECL allows for a tuning of the effective intergranular exchange-coupling in the underlying MAG, and results in improved recording performance, the overall intrinsic media noise level and thus the SNR improvement is limited by the media grain structure of the MAG.

What is needed is a perpendicular magnetic recording medium with an RL structure that takes advantage of effective intergranular exchange-coupling provided by an ECL, but wherein the SNR improvement is not limited by the media grain structure of the MAG.

### SUMMARY OF THE INVENTION

This invention is a perpendicular magnetic recording layer (RL) structure with multiple granular ferromagnetic layers (MAGs) that are separated by ferromagnetic exchange-coupling layers (ECLs) as interlayers between the MAGs. The ECLs provide effective intergranular exchange-coupling in the MAGs. Each MAG is sufficiently thick to support independent recording states that are thermally stable, and does not rely on the overall RL thickness for thermal stability. For a structure with two independent MAGs, the number of grains per area is doubled, leading to an improvement in media signal-to-noise ratio (SNR). Each ECL has significant intralayer coupling of its grains. The material of the ECL may be a CoCr alloy, such as a CoCrPtB alloy, that preferably does not include any oxide or if it does, an amount substantially less than the amount of oxide in the MAG. The Cr and B in the ECL segregate to a much smaller extent than would an oxide, so that there are small segregation regions or sub-grains in the ECL that are exchange-coupled on a length scale smaller than the grain size. Due to the small length-scale of the segregation regions within the ECLs, as compared to the larger length-scale of the grains, the intralayer exchange coupling within the ECL has multiple weak spots for each individual MAG grain. Therefore, for each MAG grain, there exist a multitude of magnetic states corresponding to different transition positions in the ECL. These magnetic states are metastable and can be produced by a recording process, which in turn allows the RL structure to support a stable magnetization pattern with different magnetization states in adjacent MAGs. Thus, the magnetization states of the various MAGs may be fully correlated, but need not be fully correlated even though their granular structure is and all layers are ferromagnetically coupled together. This allows for a substantial reduction in media noise.

The RL structure may also include coupling layers (CLs) between the ECLs and adjacent MAGs to optimize the interlayer coupling strength. This will enable the correlated and non-correlated magnetization states of the MAGs to be equally likely to be populated, so that the reduced media noise can be achieved.

The invention is also a perpendicular magnetic recording system that includes the above-described medium and a magnetic recording write head.

For a fuller understanding of the nature and advantages of the present invention, reference should be made to the following detailed description taken together with the accompanying figures.

### BRIEF DESCRIPTION OF THE DRAWING

FIG. 1 is a schematic of a prior art perpendicular magnetic recording system.

FIG. 2 is a schematic of a cross-section of a prior art perpendicular magnetic recording disk.

FIG. 3A is a schematic of a cross-section of a prior art perpendicular magnetic recording disk with a recording layer (RL) structure comprising an exchange-coupling layer (ECL) on top of a ferromagnetic layer (MAG).

FIG. 3B is a schematic illustration of the grain structure of the ECL and MAG for the RL structure of FIG. 3A.

FIG. 4 is a graph of the effective intergranular exchange-coupling strength, which is related to an exchange parameter Jc, in the MAG layer, as a function of ECL thickness t.

FIG. 5A is a transmission electron microscopy (TEM) image of a MAG with a composition of Co₅₇Pt₁₈Cr₁₇(SiO₂)₈.

FIG. 5B is a TEM image of an ECL of with a composition of Co₆₂Pt₁₂Cr₁₈B₈.

FIG. 6A is a schematic cross-sectional view of the RL structure of this invention showing two MAGs and an ECL as an interlayer between MAG1 and MAG2 with full correlation between the MAG1 and MAG2 magnetization states.

FIG. 6B is a schematic cross-sectional view of the RL structure of this invention showing another configuration wherein the top-to-bottom correlation of the magnetization states of MAG1 and MAG2 is broken at the transition.

FIG. 7 is a schematic cross-sectional view of the RL structure of this invention with multiple MAGs and ECLs and with coupling layers (CLs) between the ECLs and adjacent MAGs to optimize the interlayer coupling strength.

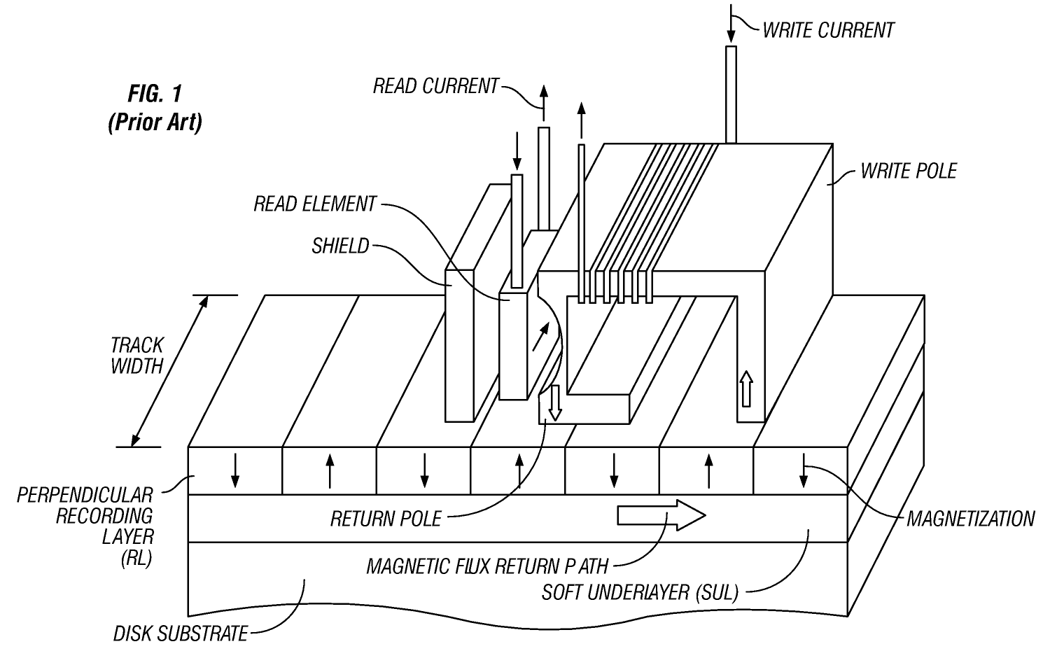

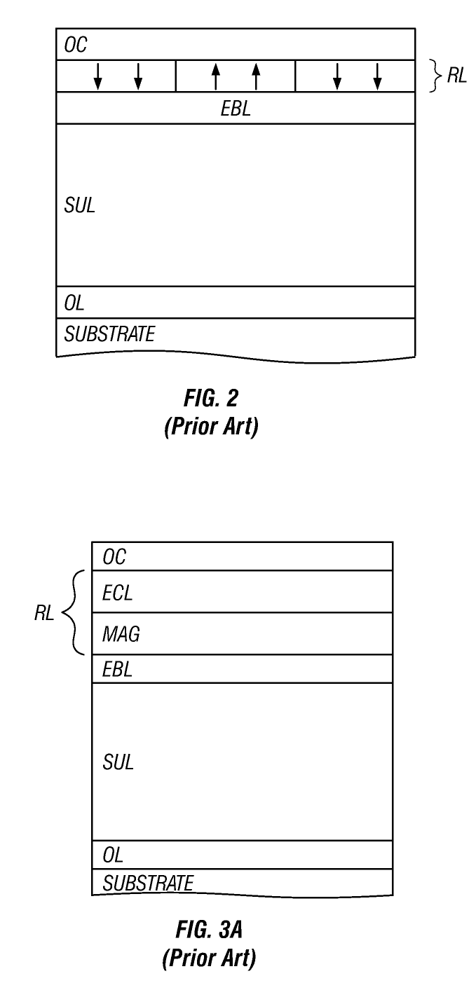

### DETAILED DESCRIPTION OF THE INVENTION

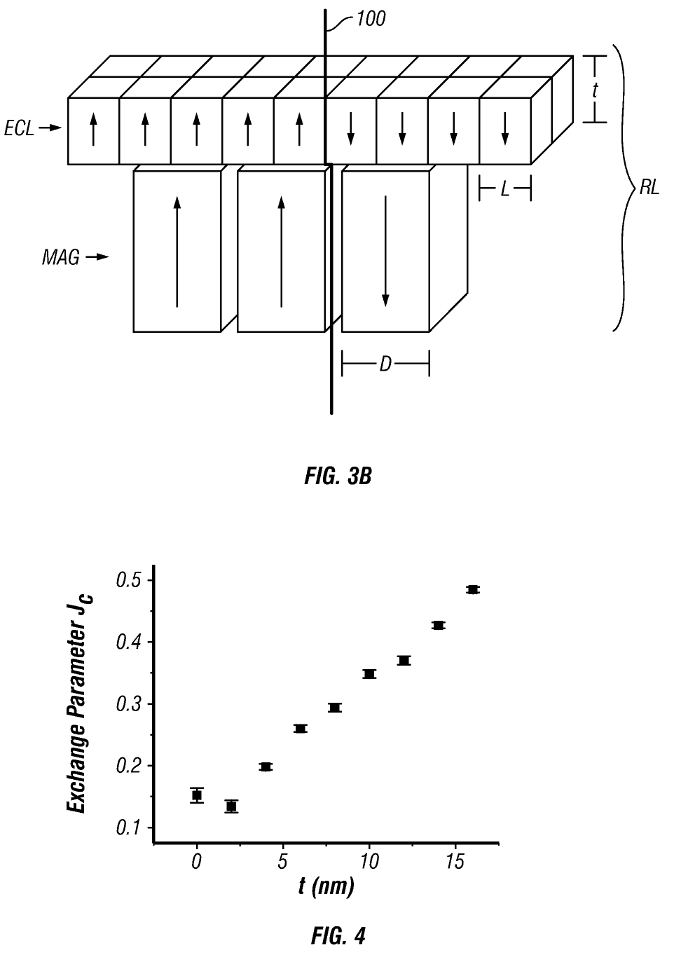

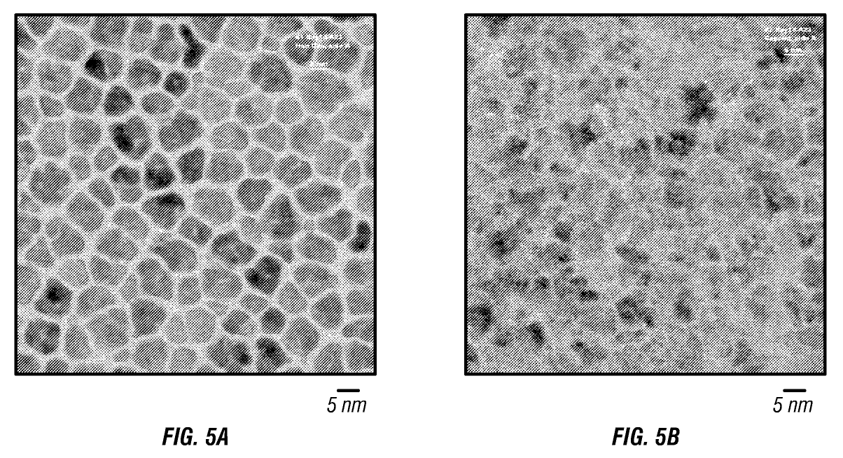

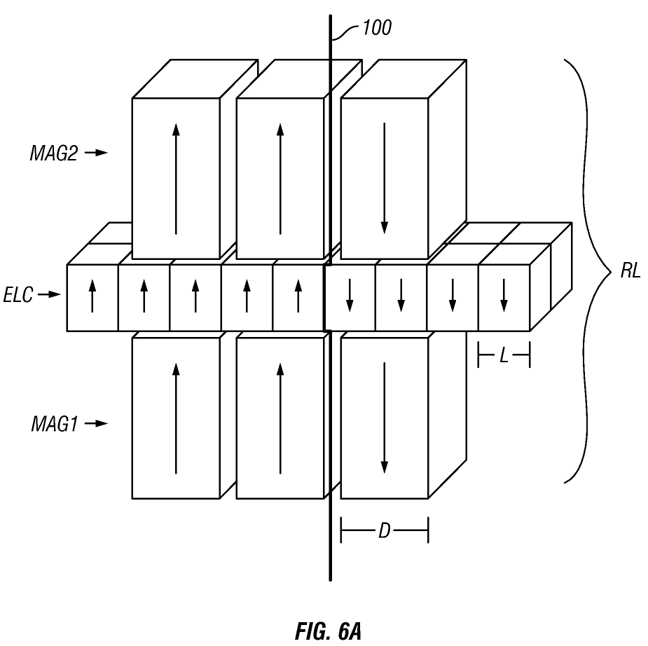

The prior art perpendicular magnetic recording medium wherein the RL includes an ECL on top of a single ferromagnetic layer (MAG) is depicted in schematic cross-section in FIG. 3A. The MAG is typically a granular Co cobalt alloy, such as a CoPt or CoPtCr alloy, with a suitable segregant such as an oxide or oxides of one or more of Si, Ta, Ti, Nb, Cr, V and B, with its easy axis of magnetization being oriented out-of-plane, i.e., generally greater than 45 degrees relative to the surface of the substrate. The ECL is deposited directly on top of and in contact with the MAG. The ferromagnetic alloy in the ECL has significant intralayer coupling of its grains. The material of the ECL may be a Co alloy, such as a CoCrPtB alloy, that preferably does not include any oxide or if it does, an amount substantially less than the amount of oxide in the MAG. The Cr and B in the ECL segregate to a much smaller extent than would an oxide, so that there are small segregation regions or sub-grains in the ECL that are exchange-coupled on a length scale smaller than the grain size. A substantial amount of oxide in the ECL would tend to completely suppress the intralayer coupling in the ECL. Because the ECL grain boundaries overlay the boundaries of the generally segregated and decoupled grains of the MAG with which it is in contact, and the ECL and MAG grains are strongly coupled perpendicularly, the ECL introduces an effective intergranular exchange-coupling in the MAG. FIG. 3B is a schematic illustration of the grain structure of the ECL and MAG. The MAG has clearly separated grains as a result of the good grain isolation typically achieved by the oxide or other segregant. The ECL of thickness t has only a limited segregation on a characteristic length scale L, which is smaller than the MAG layer grain size D. The MAG layer and ECL are coupled together by being in direct contact, for example, which enables the ECL to provide an effective intergranular coupling in between the grains of the MAG layer. The magnetization direction shown by the arrows is switched at the bit transition represented by line 100. The effective intergranular exchange-coupling strength, which is related to an exchange parameter Jc, in the MAG layer, generally increases with ECL thickness t, as shown by the graph of FIG. 4. A study of the microscopic media structure using transmission electron microscopy (TEM) has corroborated the media structure illustrated schematically in FIGS. 3A-3B, in particular the rather small segregation contrast on a length scale L that is substantially smaller than the MAG layer grain size D. FIG. 5A is a transmission electron microscopy (TEM) image of a MAG layer with a composition of Co₅₇Pt₁₈Cr₁₇(SiO₂)₈ and FIG. 5B is a TEM image of an ECL with a composition of Co₆₂Pt₁₂Cr₁₈B₈. The MAG layer and ECL show very similar crystallographic grain structures. While this RL structure allows for a tuning of the effective intergranular exchange-coupling and results in improved recording performance, the overall media noise level is still determined primarily by the media grain structure of the MAG.

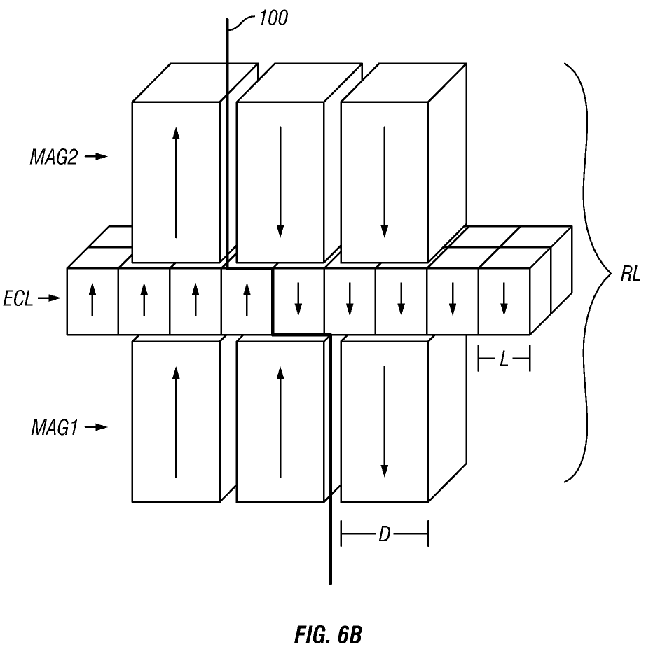

In this invention the RL structure comprises multiple granular ferromagnetic layers (MAGs) that are separated by exchange-coupling layers (ECLs) as interlayers between the MAGS to provide effective intergranular exchange-coupling in the MAGs. Due to the small length-scale of the segregation regions within the ECLs, as compared to the larger length-scale of the grains, the intralayer exchange coupling within the ECL has multiple weak spots for each individual media grain. Therefore, for each MAG grain, there exist a multitude of magnetic states corresponding to different transition positions in the ECL. These magnetic states are metastable and can be produced by a recording process, which in turn allows the RL structure to support a stable magnetization pattern with different magnetization states in adjacent MAGs. Thus, the magnetization states of the various MAGs may be fully correlated (as depicted in FIG. 6A), but need not be fully correlated even though their granular structure is and all layers are ferromagnetically coupled together (as depicted in FIG. 6B). This allows for a substantial reduction in media noise.

FIG. 6A shows a schematic of the RL structure of this invention. The RL structure comprises at least two granular ferromagnetic layers, MAG1 and MAG2, that are separated by an ECL with segregation on a characteristic length scale L that is smaller than the grain size D of MAG1 and MAG2. The grains in MAG1 and MAG2 are structurally fully correlated due to the continuation of the grain growth in the deposition process. Each MAG has a thickness to assure that the volume V of its grains is sufficient to assure thermal stability. Each MAG is thus sufficiently thick to support independent recording states that are thermally stable, and does not rely on the overall RL thickness for thermal stability. The presence of two independent MAGs doubles N, the number of grains per area, leading to an improvement in media SNR. As an example for a recorded bit transition represented by line 100, the invention is shown in one possible configuration wherein there is full correlation between the MAG1 and MAG2 magnetization states, as depicted by the arrows. However, this is not the only possible configuration that the media structure supports. FIG. 6B shows another configuration wherein the top-to-bottom correlation of the magnetization states is broken at the transition 100, despite the existence of full grain-structure correlation between MAG1 and MAG2.

The magnetization states of the bit transition in FIGS. 6A and 6B differ by only half a grain, i.e., RL structures according to the invention allow for sub-grain diameter resolution, which corresponds to a substantially reduced media noise. These different magnetization states are stable because the ECL shows a lateral modulation of its intralayer exchange-coupling on a length scale L, which is substantially smaller than the grain diameter D of MAG1 and MAG2. Thus, the ECL has sufficient fine structure to accommodate not only the fully correlated magnetization state of FIG. 6A, but also the transition-shifted magnetization state of FIG. 6B, both of which are stable magnetization states.

In FIGS. 6A-6B, MAG1 and MAG2 are each formed of a granular polycrystalline Co alloy, such as a CoPt or CoPtCr alloy, with a segregant such as an oxide or oxides of one or more of Si, Ta, Ti, Nb, Cr, V and B. MAG1 and MAG2 may have the same or different compositions. Each of MAG1 and MAG2 should have a thickness sufficient to assure that the grains are thermally stable, which for an oxide-containing CoPt or CoPtCr alloy would be greater than about 10 nm, typically in the range of about 12 to 18 nm. Thus each of MAG1 and MAG2 is capable of supporting a magnetization state independent of the other. The ECL is a ferromagnetic Co alloy that includes at least one of Cr and B, with a thickness in the range of about 1 to 8 nm. The Co alloys of the ECL may also include Pt. The ferromagnetic alloy in the ECL has significantly larger intralayer exchange coupling than the ferromagnetic alloys in MAG1 and MAG2. The ECL alloy should preferably not include an oxide, or only an amount of oxide substantially less than the amount in MAG1 and MAG2. The presence of substantial amounts of oxide would completely suppress the intralayer coupling in the ECL. The ECL is deposited directly on MAG1, with MAG2 being deposited directly on the ECL. MAG1 and MAG2 are sputter deposited at relatively high pressure (e.g., 10-30 mTorr) in the presence of oxygen. Alternatively MAG1 and MAG2 may be sputter deposited from an oxide-containing target (e.g., a Ta₂O₅ target or a SiO₂ target) either with or without the presence of oxygen in the sputtering chamber. The ECL is typically sputter deposited at lower pressure (e.g., 2-8 mTorr) without the presence of oxygen.

The complete disk structure with the RL structure of FIGS. 6A-6B would also include the additional layers like those depicted in FIG. 3A. The hard disk substrate may be any commercially available glass substrate, but may also be a conventional aluminum alloy with a NiP surface coating, or an alternative substrate, such as silicon, canasite or silicon-carbide. The adhesion layer or OL for the growth of the SUL may be an AlTi alloy or a similar material with a thickness of about 2-10 nm. The SUL may be formed of magnetically permeable materials such as alloys of CoNiFe, FeCoB, CoCuFe, NiFe, FeAlSi, FeTaN, FeN, FeTaC, CoTaZr, CoFeTaZr, CoFeB, and CoZrNb. The SUL may also be a laminated or multilayered SUL formed of multiple soft magnetic films separated by nonmagnetic films, such as electrically conductive films of Al or CoCr. The SUL may also be a laminated or multilayered SUL formed of multiple soft magnetic films separated by interlayer films that mediate an antiferromagnetic coupling, such as Ru, Ir, or Cr or alloys thereof. The EBL is located on top of the SUL. It acts to break the magnetic exchange-coupling between the magnetically permeable films of the SUL and the RL and also serves to facilitate epitaxial growth of the RL. The EBL may not be necessary, but if used it can be a nonmagnetic titanium (Ti) layer; a non-electrically-conducting material such as Si, Ge and SiGe alloys; a metal such as Cr, Ru, W, Zr, Nb, Mo, V and Al; a metal alloy such as amorphous CrTi and NiP; an amorphous carbon such as CNₓ, CHₓ and C; or oxides, nitrides or carbides of an element selected from the group consisting of Si, Al, Zr, Ti, and B. If an EBL is used, a seed layer may be used on top of the SUL before deposition of the EBL. For example, if Ru is used as the EBL, a 1-8 nm thick NiFe or NiW seed layer may be deposited on top of the SUL, followed by a 3-30 nm thick Ru EBL. The EBL may also be a multilayered EBL. The OC formed on top of the RL structure may be an amorphous “diamond-like” carbon film or other known protective overcoats, such as Si-nitride.

The RL structure of this invention may also include additional MAGs with additional ECLs between adjacent MAGs. For example, referring to FIG. 6A, a second ECL may be formed on top of MAG2 with a third ferromagnetic layer MAG3 formed on top of the second ECL.

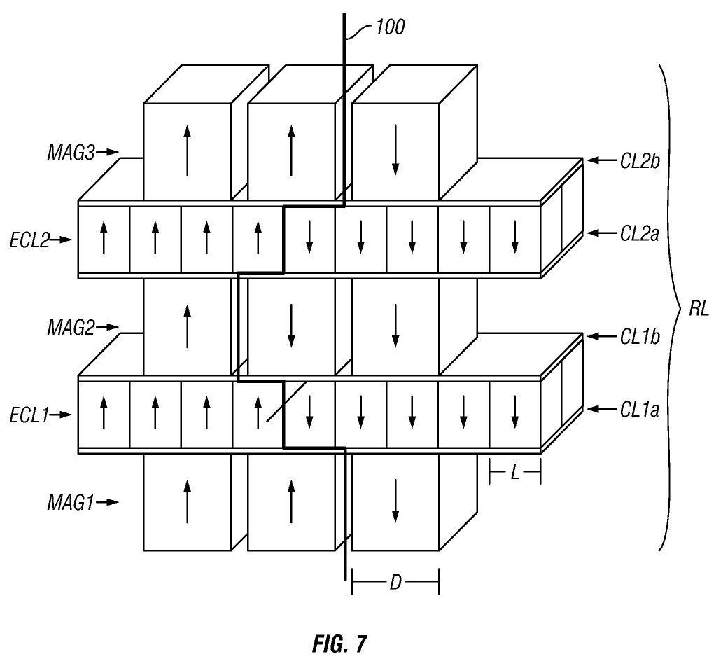

In this invention, it may be advantageous to introduce coupling layers (CLs) between the ECLs and adjacent MAGs to optimize the interlayer coupling strength, to either reduce or enhance it, so that the magnetization states in FIGS. 6A and 6B are equally likely to be populated and the best possible noise performance can be achieved. FIG. 7 depicts such a RL structure with multiple MAGs and ECLs. Two coupling layers, CL1a and CL1b, are located on opposite sides of ECL1, and two coupling layers, CL2a and CL2b, are located on opposite sides of ECL2. A structure with only one coupling layer, for example just CL1a or CL1b, would also be suitable.

Because each CL is below a MAG, it should be able to sustain the growth of the MAG, while mediating a weak ferromagnetic coupling between the adjacent ECLs or MAGs. Hexagonal-close-packed (hcp) materials for instance, which can mediate a weak ferromagnetic coupling and provide a good template for the growth of a MAG, are good candidates. Because the CL must enable an appropriate coupling strength, it should be either nonmagnetic or weakly ferromagnetic. Thus the CL may be formed of RuCo and RuCoCr alloys with sufficiently low Co content (< about 60 atomic percent), or CoCr and CoCrB alloys with high Cr and/or B content (Cr+B> about 30 atomic percent). Si-oxide or other oxides like oxides of Ta, Ti, Nb, Cr, V and B may be added to these alloys in an amount up to about 15 atomic percent. Depending on the choice of material for CL, and more particularly on the concentration of cobalt (Co) in the CL, the CL may have a thickness of less than 3.0 nm, and more preferably between about 0.2 nm and 1.5 nm, although in certain embodiments, the thickness of the CL may exceed 1.5 nm. Because Co is highly magnetic, a higher concentration of Co in the CL may be offset by thickening the CL to achieve an optimal interlayer exchange-coupling between the adjacent MAGs. The interlayer exchange-coupling between adjacent MAGs and ECLs may be optimized, in part, by adjusting the materials and thickness of the CLs and the ECLs. The CLs and the ECL together should provide a coupling strength that is small enough to not couple the adjacent MAGs rigidly together.

To achieve high performance perpendicular magnetic recording disks at ultra-high recording densities, e.g., greater than about 200 Gbits/in², the RL should exhibit a coercivity H_{c} greater than about 4000 Oe and a nucleation field Hₙ greater (more negative) than about −1500 Oe. The nucleation field Hₙ is the reversing field, preferably in the second quadrant of the M-H hysteresis loop, at which the magnetization begins to drop from its saturation value (Mₛ). The more negative the nucleation field, the more stable the remanent magnetic state will be because a larger reversing field is required to alter the magnetization. Experimental structures like that depicted in FIGS. 6A-6B have been fabricated. For a specific embodiment with CoPtCr—TaOx(14 nm)/CoPtCrB(4 nm)/CoPtCr—SiOx(14 nm) as the MAG1/ECL/MAG2 RL structure, the coercivity H_{c} was 5490 Oe and the nucleation field Hₙ was −3360 Oe. The high Hₙ value demonstrates that such media structures can be grown with magnetic properties that are suitable for perpendicular recording.

While the present invention has been particularly shown and described with reference to the preferred embodiments, it will be understood by those skilled in the art that various changes in form and detail may be made without departing from the spirit and scope of the invention. Accordingly, the disclosed invention is to be considered merely as illustrative and limited in scope only as specified in the appended claims.

What is claimed is:

1. A perpendicular magnetic recording medium comprising:
a substrate;
a first ferromagnetic layer on the substrate and having an out-of-plane easy axis of magnetization, the first ferromagnetic layer comprising an oxide for reducing intergranular exchange-coupling;
a second ferromagnetic layer having an out-of-plane easy axis of magnetization, the second ferromagnetic layer comprising an oxide for reducing intergranular exchange-coupling; and
a ferromagnetic interlayer between the first and second ferromagnetic layers for enhancing the intergranular exchange-coupling in the first and second ferromagnetic layers, the ferromagnetic interlayer comprising a substantially oxide-free Co alloy.

2. The medium of claim 1 each of the first and second ferromagnetic layers comprises an alloy comprising Co and Pt.

3. The medium of claim 2 wherein the oxide in each of the first and second ferromagnetic layers comprises an oxide of one or more elements selected from the group consisting of Si, Ta, Ti, Nb, Cr, V and B.

4. The medium of claim 3 each of the first and second ferromagnetic layers has a thickness greater than about 10 nanometers.

5. The medium of claim 1 wherein the ferromagnetic interlayer is an alloy comprising Co and Cr.

6. The medium of claim 5 wherein the ferromagnetic interlayer is an alloy comprising Co, Cr and B.

7. The medium of claim 1 wherein the ferromagnetic interlayer is in contact with each of the first and second ferromagnetic layers.

8. The medium of claim 1 further comprising a coupling layer between the ferromagnetic interlayer and at least one of said first and second ferromagnetic layers, the coupling layer comprising a material selected from the group consisting of (a) a RuCo alloy with Co less than about 60 atomic percent, (b) a RuCoCr alloy with Co less than about 60 atomic percent, and (c) an alloy of Co and one or more of Cr and B with the combined content of Cr and B greater than about 30 atomic percent.

9. The medium of claim 8 wherein the coupling layer further comprises one or more oxides of one or more elements selected from the group consisting of Si, Ta, Ti, Nb, Cr, V and B.

10. The medium of claim 1 wherein the ferromagnetic interlayer is a first interlayer and further comprising (a) a third ferromagnetic layer having an out-of-plane easy axis of magnetization and comprising an oxide for reducing intergranular exchange-coupling, and (b) a second ferromagnetic interlayer between the second and third ferromagnetic layers for enhancing the intergranular exchange-coupling in the second and third ferromagnetic layers, the second ferromagnetic interlayer comprising a substantially oxide-free Co alloy.

11. The medium of 1 further comprising an underlayer of magnetically permeable material on the substrate and an exchange break layer between the underlayer and the first ferromagnetic layer for preventing magnetic exchange-coupling between the underlayer and the first ferromagnetic layer.

12. A perpendicular magnetic recording disk comprising:
a substrate having a generally planar surface;
an underlayer of magnetically permeable material on the substrate surface;
a first ferromagnetic layer on the underlayer, the first ferromagnetic layer having an out-of-plane easy axis of magnetization and comprising a granular polycrystalline cobalt alloy and an oxide of one or more of Si, Ta, Ti, Nb, Cr, V and B;
a ferromagnetic interlayer on the first ferromagnetic layer, the interlayer comprising a substantially oxide-free ferromagnetic alloy comprising Co and Cr; and
a second ferromagnetic layer on the interlayer, the second ferromagnetic layer having an out-of-plane easy axis of magnetization and comprising a granular polycrystalline cobalt alloy and an oxide of one or more of Si, Ta, Ti, Nb, Cr, V and B.

13. The disk of claim 12 wherein each of the first and second ferromagnetic layers has a thickness greater than about 10 nanometers.

14. The disk of claim 12 wherein the interlayer alloy includes B.

15. The disk of claim 12 wherein the interlayer alloy includes Pt.

16. The disk of claim 12 wherein the interlayer is in contact with each of the first and second ferromagnetic layers.

17. The disk of claim 12 further comprising a coupling layer between the interlayer and at least one of said first and second ferromagnetic layers, the coupling layer comprising a material selected from the group consisting of (a) a RuCo alloy with Co less than about 60 atomic percent, (b) a RuCoCr alloy with Co less than about 60 atomic percent, and (c) an alloy of Co and one or more of Cr and B with the combined content of Cr and B greater than about 30 atomic percent.

18. The disk of claim 17 wherein the coupling layer further comprises one or more oxides of one or more elements selected from the group consisting of Si, Ta, Ti, Nb, Cr, V and B.

19. The disk of claim 12 wherein the interlayer is a first interlayer and further comprising (a) a third ferromagnetic layer having an out-of-plane easy axis of magnetization and comprising a granular polycrystalline cobalt alloy and an oxide of one or more of Si, Ta, Ti, Nb, Cr, V and B, and (b) a second ferromagnetic interlayer between the second and third ferromagnetic layers and comprising a substantially oxide-free ferromagnetic alloy comprising Co and Cr.

20. The disk of claim 12 further comprising an exchange break layer between the underlayer and the first ferromagnetic layer for preventing magnetic exchange-coupling between the underlayer and the first ferromagnetic layer.

21. A perpendicular magnetic recording system comprising:
the disk of claim 12;
a write head for magnetizing regions in the recording layer of said disk, said recording layer comprising the first ferromagnetic layer, the interlayer, and the second ferromagnetic layer; and
a read head for detecting the transitions between said magnetized regions.
